(19) United States
(12) Patent Application Publication
(10) Pub. No.: US 2023/0165738 A1
(43) Pub. Date: Jun. 1, 2023

(54) PERSONAL CONVEYANCE APPARATUS AND SYSTEM

(71) Applicant: Roger D. Dorminey, Tifton, GA (US)

(72) Inventor: Roger D. Dorminey, Tifton, GA (US)

(21) Appl. No.: 17/839,134

(22) Filed: Jun. 13, 2022

Related U.S. Application Data
(60) Provisional application No. 63/316,005, filed on Mar. 3, 2022.
(60) Provisional application No. 63/258,993, filed on Jun. 14, 2021.

(51) Int. Cl. A61G 3/06

(52) U.S. Cl. CPC A61G 3/062

(57) ABSTRACT

Apparatus for carrying a personal conveyance device on a vehicle and transporting the personal conveyance device around the vehicle.

### CROSS REFERENCE TO RELATED APPLICATIONS

This application is being filed as a Non-Provisional Patent Application in the name of Roger D. Dorminey, a U.S. citizen, claiming priority to U.S. Provisional Patent Application Ser. No. 63/258,993 filed on 14 Jun. 2021 and entitled “TRANSPORTATION, RETRIEVAL AND POSITIONING OF A PERSONAL CONVEYANCE” and also claiming priority to U.S. Provisional Patent Application Ser. No. 63/316,005 filed on 3 Mar. 2022 and entitled “PERSONAL CONVEYANCE APPARATUS AND SYSTEM.” The contents of the latter Provisional Application are incorporated herein in its entirety.

### FIELD OF THE INVENTION

The present invention is directed to at least one personal conveyance apparatus that includes a carrier for holding and transporting the personal conveyance device on a vehicle. The present invention is also directed to a system comprising a programmable computer and a carrier for holding and transporting a personal conveyance device on a vehicle.

### BACKGROUND OF THE INVENTION

There is a need in the art for an apparatus and system for holding and transporting personal conveyance devices on and around vehicles such that a driver may transport, retrieve and position, for use without assistance, a personal conveyance device. There is also a need in the art for a programmable system for holding and transporting personal conveyance devices on and around vehicles such that a driver may transport, retrieve and position a personal conveyance device automatically without third party assistance.

### SUMMARY OF THE INVENTION

The present invention relates to the discovery of at least one apparatus for carrying a personal conveyance device on a vehicle and transporting the personal conveyance device around the vehicle; comprising a carrier for holding the personal conveyance device; a transport rack rail mounted on the vehicle on which the carrier is transported around the vehicle; and a drive module coupled to the carrier that transports the carrier on the transport rack rail. The disclosed at least one apparatus for carrying and transporting a personal conveyance device provides a number of advantages over known vehicle personal conveyance systems. For example, the disclosed at least one apparatus for carrying and transporting a personal conveyance device allows a driver of a vehicle to access a personal conveyance device without third party assistance. In addition, the disclosed at least one apparatus for carrying and transporting a personal conveyance device allows for the storage of a personal conveyance device on a secure location of a vehicle.

The present invention also relates to the discovery of at least one apparatus for carrying a personal conveyance device on the rear of a vehicle and transporting the personal conveyance device around the vehicle, including a carrier for holding the personal conveyance device; a transport rack rail mounted on the vehicle upon which the carrier is transported around the vehicle; and a drive module coupled to the carrier that transports the carrier on the transport rack rail; and wherein the carrier, when located at the rear of the vehicle, is proximate to a fixed base that supports the carrier.

In another exemplary embodiment, the present invention is directed to at least one system including a computer programmed to do the following: upon receiving a user input, transmits instructions to a receiver located in a drive module to activate a drive system that transports a carrier having a personal conveyance device thereon from the rear of a vehicle to a side door of the vehicle, wherein the carrier is transported to the side door of the vehicle using a transport rack rail that is coupled to the rear and side of the vehicle, and wherein the carrier is transported on the transport rack rail using a drive module. The disclosed at least one system for carrying and transporting a personal conveyance device provides a number of advantages over known vehicle personal conveyance systems. For example, in one embodiment of the present invention the disclosed at least one apparatus for carrying and transporting a personal conveyance device allows a driver of a vehicle to easily access a personal conveyance device at the driver's door using a convenient controller.

In one exemplary embodiment, the present invention is directed to at least one vehicle comprising an apparatus for carrying a personal conveyance device on the vehicle and transporting the personal conveyance device around the vehicle; including a carrier for holding the personal conveyance device; a transport rack rail mounted on the vehicle that transports the carrier around the vehicle; and a drive module coupled to the carrier that transports the carrier on the transport rack rail.

These and other features and advantages of the present invention will become apparent after a review of the following detailed description of the disclosed exemplary embodiments and the appended claims.

### BRIEF DESCRIPTION OF THE FIGURES

FIG. 1 depicts an exemplary apparatus according to the present invention for carrying a personal conveyance device on a vehicle and transporting the personal conveyance device around the vehicle;

FIG. 2 depicts an exemplary apparatus according to the present invention for carrying a personal conveyance device on a vehicle and transporting the personal conveyance device around the vehicle;

FIG. 3 depicts an exemplary apparatus according to the present invention for carrying a personal conveyance device on a vehicle and transporting the personal conveyance device around the vehicle; and

FIG. 4 depicts an exemplary apparatus according to the present invention for carrying a personal conveyance device on a vehicle and transporting the personal conveyance device around the vehicle.

### DETAILED DESCRIPTION OF THE INVENTION

To promote an understanding of the principles of the present invention, descriptions of specific exemplary embodiments of the invention follow, and specific language is used to describe the specific exemplary embodiments. It will nevertheless be understood that no limitation of the scope of the invention is intended by the use of specific language. Alterations, further modifications, and such further applications of the principles of the present invention discussed are contemplated, as would normally occur to one ordinarily skilled in the art to which the invention pertains. Also, it is intended that the phraseology and terminology used herein is for the purpose of description and should not be regarded as limiting.

It must be noted that as used herein and in the appended claims, the singular forms “a”, “and”, and “the” include plural referents unless the context clearly dictates otherwise. Thus, for example, reference to “an apparatus” or “a system” includes a plurality of such apparatus or systems and reference to “apparatus” or “system” includes reference to at least one apparatus or system and equivalents thereof known to those skilled in the art, and so forth.

As used herein, the use of the terms “including”, “comprising”, or “having” and variations thereof is meant to encompass the embodiments set forth herein and equivalents thereof, as well as additional components.

“About” modifying, for example, the quantity of an ingredient in a composition, concentrations, volumes, process temperatures, process times, properties, pressures, and like values, and ranges thereof, employed in describing the exemplary embodiments of the disclosure, refers to variation in the numerical quantity that may occur, for example, through typical measuring and handling procedures; through inadvertent error in these procedures; through differences in the ingredients used to carryout the methods; and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

As used herein, the term “substantially” means within a reasonable amount, but includes amounts which vary from about 0% to about 50% of the absolute value, from about 0% to about 40%, from about 0% to about 30%, from about 0% to about 20% or from about 0% to about 10%.

As used herein, the term “computer” means a programmable computing device capable of storing digital instructions, and upon demand, electronically transmit the instructions to a sensitive receiver.

As used herein, the term “coupled” means an object near or next to another object, or an object indirectly or directly connected to another object.

As used herein, the term “personal conveyance device” means a wheelchair type device that is capable of transporting at least one individual, whether motorized or not, including but not limited to a wheelchair, a motor chair or a scooter, or the like.

As used herein, the term “vehicle” means any motor vehicle that transports people, such as sedans, trucks, vans, SUVs, tractors, ATVs or the like.

As used herein, the term “carrier” means a platform or holder that is capable of carrying, moving or transporting a personal conveyance device.

As used herein, the term “transport rack rail system” means a rack and pinion rail system, a chain and sprocket rail system, a worm drive rail system, or any other mechanical drive system.

As used herein, the term “transport rack rail” means a linear mechanical rack rail that is sufficient for holding and transporting a carrier including a personal conveyance device.

As used herein, the term “fixed base” means any base coupled to a vehicle, such as for example, a ball trailer hitch, a fifth wheel hitch or the like.

As used herein, the term “drive module” means a module that includes at least one drive component, power supply and electronic receiver.

As used herein, the term “rack and pinion system” means a transport rack rail system including a linear rack rail in which a circular gear or pinion is engaged and meshed with teeth of the linear rack rail. As used herein, the term “teeth” means projecting portions of the transport rack rail that extend from the surface of the transport rack rail such that the teeth of the linear rack rail may engage and mesh with the pinion located in the power pinion drive module.

As used herein, the term “lift” means a mechanical device that is capable of lifting and lowering a carrier.

As used herein, the terms “mounted”, “connected”, “supported”, and “coupled” and variations thereof are used broadly and include direct and indirect mountings, connections, supports, and couplings. In addition, the terms “connected” and“coupled” are not restricted to physical or mechanical connections or couplings. In the description below, like reference numerals and labels are used to describe the same, similar or corresponding parts in the figures.

The disclosed apparatus or system is not limited in its application to the details of construction and the arrangement of components set forth in the following description or illustrated in the following drawings. The described apparatus or system may be used in many applications and in various embodiments. For example, the personal conveyance apparatus or system that includes a carrier for holding and transporting the personal conveyance device on a vehicle of the present invention may be used in any configuration and with numerous vehicles, including but not limited to, sedans, trucks, vans, SUVs, tractors, ATVs and the like.

The present invention relates to the discovery of an apparatus or system that allows the driver of a vehicle to transport, retrieve and position a personal conveyance device (e.g., a wheelchair type device) that is transported on the driver's vehicle. This allows the driver of the vehicle to be independent of third party assistance, which is normally required to achieve the use of the personal conveyance device. The disclosed vehicle apparatus or system for transporting, retrieving and positioning a personal conveyance device provide a number of advantages over known vehicle apparatus or systems for transporting, retrieving and positioning a personal conveyance device. For example, the disclosed vehicle apparatus or system for transporting, retrieving and positioning a personal conveyance device is compact and an efficient design, which decreases the cost of the apparatus. In addition, the disclosed vehicle apparatus or system for transporting, retrieving and positioning a personal conveyance device allows the driver to retrieve the personal conveyance device without the assistance of another person.

The present invention also relates to the discovery that the disclosed vehicle apparatus or system for transporting, retrieving and positioning a personal conveyance device allows a driver to transport and position the personal conveyance device automatically in a manner that allows the conveyance device to be available for use. In an exemplary embodiment, the present invention is directed to at least one system including a computer programmed to do the following: upon receiving a user input, transport a carrier having a personal conveyance device thereon from the rear of a vehicle to a side door of the vehicle, wherein the carrier is transported to the side door of the vehicle using a transport rack rail that is coupled to the rear and side of the vehicle, and wherein the carrier is transported on the transport rack rail using a drive module. Functions of the apparatus or system according to the invention may be preprogrammed in the apparatus or system computer and controlled by the driver using a hand-held electronic control device or similar, such as a remote.

In another exemplary embodiment, the present invention relates to the discovery of at least one apparatus for carrying a personal conveyance device on a vehicle and transporting the personal conveyance device around the vehicle; comprising a carrier for holding the personal conveyance device; a transport rack rail mounted on the vehicle on which the carrier is transported around the vehicle; and a drive module coupled to the carrier that transports the carrier on the transport rack rail. In one exemplary embodiment, the carrier, when located at the rear of the vehicle, is proximate to a fixed base that supports the carrier. In another exemplary embodiment, the fixed base may be coupled to the vehicle, such as for example, a ball trailer hitch, a fifth wheel hitch, or the like.

In a further exemplary embodiment, the present invention is directed to at least one vehicle comprising an apparatus for carrying a personal conveyance device on the vehicle and transporting the personal conveyance device around the vehicle; including a carrier for holding the personal conveyance device; a transport rack rail mounted on the vehicle that transports the carrier around the vehicle; and a drive module coupled to the carrier that transports the carrier on the transport rack rail.

In one exemplary embodiment, the personal conveyance device is transported on the carrier to a desired location. In another exemplary embodiment, the personal conveyance device is a wheelchair, a motor chair, a scooter or other personal conveyance device. In one exemplary embodiment, the transport rack rail is a rack and pinion rail, a chain and sprocket rail, a worm drive rail, or any other mechanical drive system. In a further exemplary embodiment, the transport rack rail is one continuous rack or is in segments that are coupled to each other. In one exemplary embodiment, the transport rack rail comprises segments that can be detached and reattached to the vehicle when the use of the rear door of the vehicle is desired or maintenance of the rear tire is required. In another exemplary embodiment, the transport rack rail is coupled to the vehicle via support arms affixed to a portion of the vehicle. In a further exemplary embodiment, the drive module is a power pinion module, or chain and sprocket module, or worm drive module. In another exemplary embodiment, the carrier includes a lift affixed thereto, which allows the carrier to be lowered or raised to a desired location.

In a further exemplary embodiment, the present invention is also directed to a method of using at least one apparatus or system for carrying a personal conveyance device on a vehicle and transporting the personal conveyance device around the vehicle; comprising a carrier for holding the personal conveyance device; a transport rack rail mounted on the vehicle on which the carrier is transported around the vehicle; and a drive module coupled to the carrier that transports the carrier on the transport rack rail.

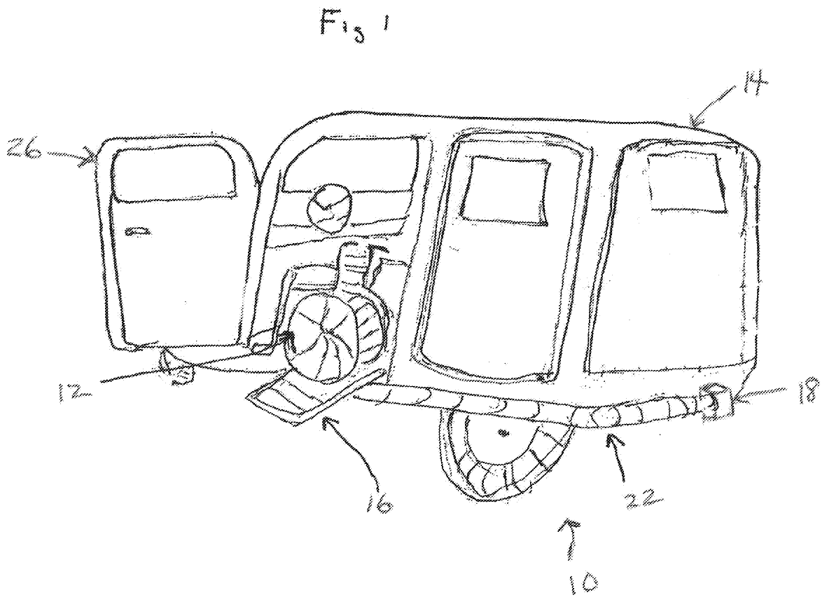

For purposes of explanation and illustration, and not limitation, a view of an exemplary embodiment of an apparatus or system for carrying a personal conveyance device on a vehicle and transporting the personal conveyance device around the vehicle, made in accordance with the present invention, is depicted in FIG. 1. As will be described in more detail, an exemplary embodiment of this invention allows for the transfer of a personal conveyance device from a position on the vehicle to another position, enabling the driver to situate him/herself on the personal conveyance and use it to travel to a destination, without the assistance of another person, as described herein. In an exemplary embodiment, the apparatus or system 10 for carrying a personal conveyance device 12 on a vehicle 14 and transporting the personal conveyance device 12 around the vehicle 14, is set forth in FIG. 1. The carrier 16 is mounted on the vehicle 14 such that it can be located in a position that allows for operation of the vehicle 14, such as in the rear of the vehicle 14. The size of the carrier 16 is such that it is capable of accommodating the personal conveyance device 12 to be transported. Even though the carrier 16 of this embodiment of the present invention is flat and rectangular in shape, other shapes may be used, such as square, or circular, and the like. Furthermore, the carrier 16 may be expandable or slotted, and may fold up against the vehicle 14 when not in use. The carrier 16 may be constructed of any material capable of supporting a personal conveyance device 12, such as metal or plastic or combination thereof. In one embodiment, the carrier 16 is constructed of aluminum, steel, or the like, and further including alloys thereof. In another exemplary embodiment, the carrier 16 is coupled to the vehicle 14 via a power drive module. In a further exemplary embodiment, the carrier 16 coupled to a fixed base 18 that supports the carrier 16. In an even further embodiment, the carrier 16 may be coupled to or decoupled from the fixed base 18, as desired, and used to transport the personal conveyance device 12 to a desired position via a transport rack rail system 22. In exemplary embodiments, the fixed base 18 may be a ball type trailer hitch or a fifth wheel type trailer hitch, or the like

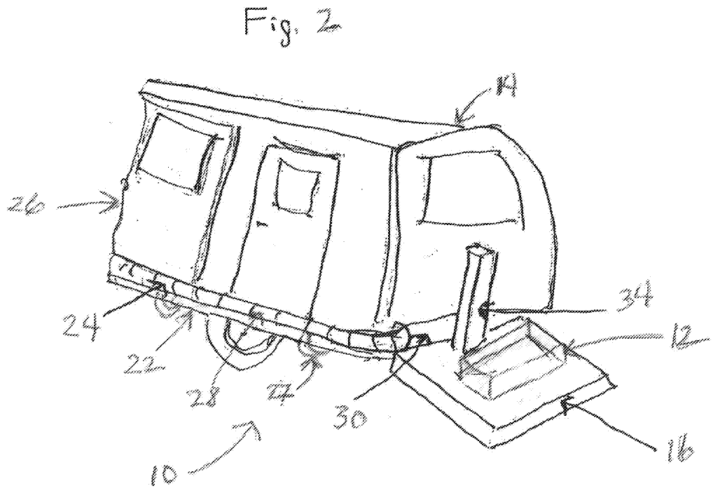

For purposes of explanation and illustration, and not limitation, a view of an exemplary embodiment of an apparatus or system 10 for carrying a personal conveyance device 12 on a vehicle 14 and transporting the personal conveyance device 12 around the vehicle 14 on a carrier 16, made in accordance with the present invention, is depicted in FIG. 2. In one exemplary embodiment of the invention, the transport of the personal conveyance device 12 is performed on a carrier 16 around the vehicle via the use of a transport rack rail system 22. In this embodiment, the transport rack rail system 22 includes a transport rack rail 24 along which the carrier 16 is transported. The transport rack rail system 22 extends along the rear of the vehicle 14 and curves around the corner and then extends along the side of the vehicle 14 to a desired location. In another exemplary embodiment, the transport rack rail system 22 extends up to the driver side door 26, so that when open, it will allow for the driver to access the personal conveyance device 12 located on the carrier 16, without the assistance of another person. In a further embodiment, the transport rack rail system 22 extends a distance away from the vehicle 14 allowing the passage of the carrier 16 around the vehicle 14. In one embodiment of the present invention, the transport rack rail system 22 is supported and secured to the vehicle by metal arms or support struts 27 that extend from the vehicle 14. In a further exemplary embodiment, the support arms or struts 27 extend from the frame of the vehicle 14, and may be affixed thereto by welding, by bolting, or the like. In one exemplary embodiment, the transport rack rail 24, as an alternative to a single piece, may be comprised of detachable segments 28, such that the transport rack rail segments 28 may be detached and reattached to the vehicle 14 when the use of the rear door of the vehicle 14 is desired or maintenance of the rear tire is required. In one exemplary embodiment, the transport rack rail system 22 may comprise one of a rack and pinion system, a sprocket drive system or a worm drive system.

In another exemplary embodiment, the transport rack rail system 22 entails the use of a rack and pinion method of power transmission, as used in various mechanical systems. For example, the Bruno curved stair lift device, as well as the Harmar Helix curved stair lift, employs a rack and pinion method of power transmission. In a further exemplary embodiment of the present invention, a power pinion drive module 30 is coupled to the carrier 16, and is also coupled and meshed to the transport rack rail system 22. In one exemplary embodiment, the carrier 16 is mounted on the power pinion drive module 30 and the power drive module 30 may be mounted and meshed with the transport rack rail system 22, such that a drive shaft (not shown) in the power pinion drive module 30 turns the drive of the pinion meshed with the transport rack rail system 22. The transport rack rail 24 comprises a typical rack configuration, which includes a row of teeth (not shown) in which a pinion (not shown) is meshed. The teeth (not shown) of the rack extend from the surface of the transport rack rail 24 support structure so that the teeth of the rack may engage and mesh with the pinion (not shown) located in the power pinion drive module 30. During operation, the power pinion drive module 30 turns the pinion, which in turn, moves the module down the rack of the transport rack rail 24.

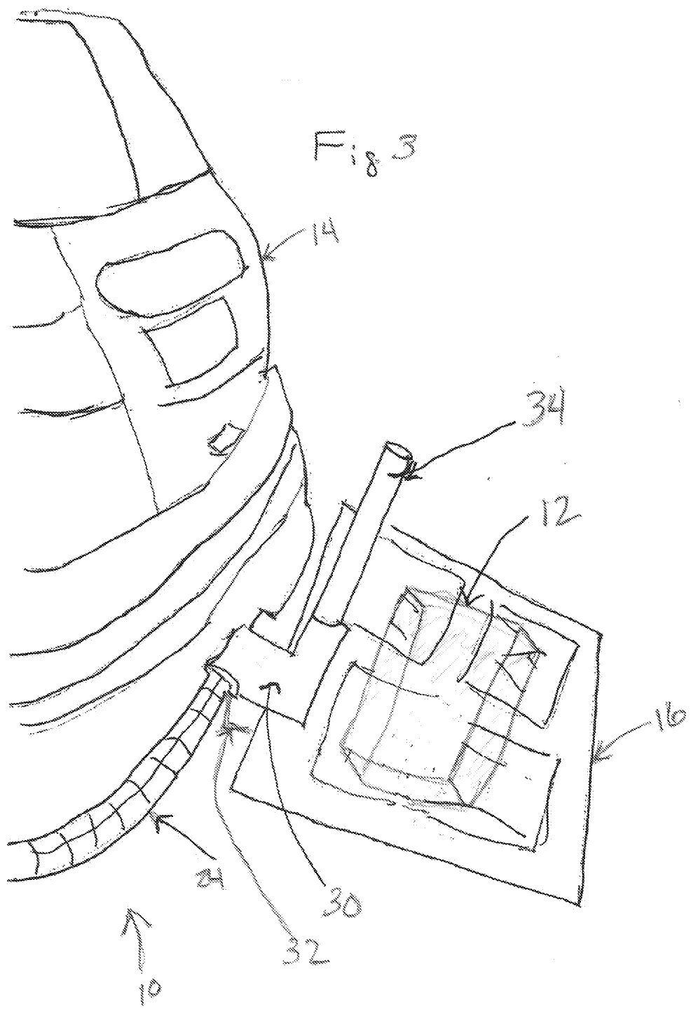

For purposes of explanation and illustration, and not limitation, a view of an exemplary embodiment of an apparatus or system 10 for carrying a personal conveyance device 12 on a vehicle 14 and transporting the personal conveyance device 12 around the vehicle 14, made in accordance with the present invention, is depicted in FIG. 3. In a further exemplary embodiment, power drive module 30 is electrically connected to at least one power module 32, which may include at least one rechargeable battery (not shown). In this embodiment, the power drive module 30 includes at least one electric motor (not shown), that when activated on demand, turns the pinion drive, sprocket drive or worm drive engaged with the transport rack rail 24. This action causes the carrier 16 to be moved along the transport rack rail 24. Alternatively, in another embodiment, the power drive module 30 also includes components of the power module 32 (e.g., at least one power source, such as a battery or other power source) combined in one housing.

In another exemplary embodiment, the power drive module 30 is a power pinion drive module 30 that includes at least one electric motor (not shown), that when activated on demand, turns the drive shaft of a pinion meshed with the transport rack rail 24. This action causes the carrier 16 to be moved along the transport rack rail 24. This mechanism is not unlike but similar to that of some drive components used in various commercial stair lift systems. Even though this embodiment describes a power pinion drive module 30, the carrier 16 may be transported around the vehicle using alternative means, such as a chain and sprocket drive, a worm drive, or the like.

In another exemplary embodiment, a power lift 34, which lowers and raises the carrier 16, is coupled to the power drive module 30 and the carrier 16. The lift 34 is transported along with the power drive module 30, optionally with the power module 32 or integrated together with the power module 32, and the carrier 16, with or without the personal conveyance device 12, around the vehicle 14 to a location desired by the driver. In an exemplary embodiment, a power lift 34 that may be included is the Harmar hitch mounted lift, which is available from Harmar Mobility, as well as other similar lifts. Once the carrier 16 is in the desired location, the driver either lowers or raises the carrier 16 using the lift 34 to place the personal conveyance device 12 in a location where it is accessible to the driver, so as to allow access to the personal conveyance device 12.

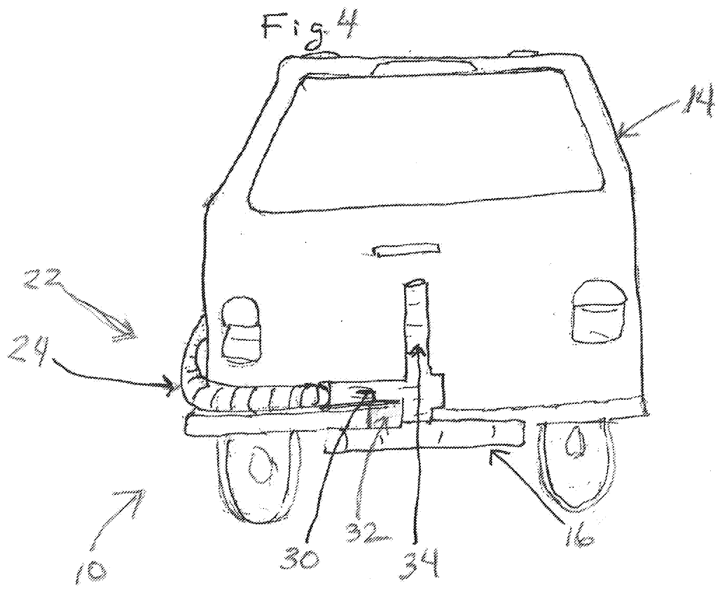

For purposes of explanation and illustration, and not limitation, a view of an exemplary embodiment of an apparatus or system 10 for carrying a personal conveyance device 12 (not shown) on a vehicle 14 and transporting the personal conveyance device 12 (not shown) around the vehicle 14, made in accordance with the present invention, is depicted in FIG. 4. The invention also allows the carrier 16, on which the personal conveyance device 12 (not shown) is transported, to be returned to a position at the rear of the vehicle after the driver and personal conveyance device 12 (not shown) are moved from the carrier 16. In one exemplary embodiment of the personal conveyance system 10 of the present invention, the driver of a vehicle 14 may, from the driver's position in the vehicle 14, automatically retrieve, access and return to its previous position, a personal conveyance device 12 (not shown), typically located on a carrier 16 at the rear of the vehicle 14. Once a driver desires to retrieve the carrier 16 to be transported around the vehicle 14 to a position where the driver can move him/herself onto the personal conveyance device 12 (not shown), he/she may then activate the personal conveyance device 12 for normal use. In one exemplary embodiment, the driver may activate the system 10 with controls (not shown) in the vehicle 14 or may use a hand-held wireless device (not shown). In another exemplary embodiment, a computer device (not shown) may be programmed to receive input from the driver, and subsequently perform the functions of the personal conveyance system 10 as requested by the driver. When the personal conveyance system 10 is activated by the driver, the carrier 16 is moved along the transport rack rail 24 using the transport rack rail system 22, via the power module 32 and power drive module 30, around the vehicle 14 to a location suitable for the driver to access the personal conveyance device 12 (not shown). Typically, the location desired by the driver is a position where, when the front door is open, the driver may easily position him/herself on the personal conveyance device 12 (not shown), such as near the front door. In one exemplary embodiment, once the personal conveyance device 12 (not shown) is near the front door 26 (not shown), the driver may raise or lower the carrier 16 using the lift 34, and then move onto the personal conveyance device 12 (not shown). The driver then may move the personal conveyance device 12 (not shown) off of the carrier 16 and proceed as desired. In another exemplary embodiment, the driver may move onto the personal conveyance device 12 (not shown), which is situated on the carrier 16, before lowering it using the lift 34 to a desired location. Subsequently, the driver may move the personal conveyance device 12 (not shown) off of the carrier 16 and proceed as desired. As mentioned previously, the driver may then direct the lift 34 to raise the carrier 16 and then send the carrier 16 to a position, either at the rear of the vehicle 14, or remain at the open door for reentry of the vehicle 14 by the driver. Once situated on the personal conveyance device 12 (not shown), the driver may manipulate the personal conveyance device 12 (not shown) off the carrier 16 and continue use of the personal conveyance device 16 in a normal manner. The driver may then, via a hand-held electronic wireless control device, instruct the carrier 16 to return to the original position at the rear of the vehicle 10.

While the invention has been described with a limited number of exemplary embodiments, these specific exemplary embodiments are not intended to limit the scope of the invention as otherwise described and claimed herein. It may be evident to those of ordinary skill in the art upon review of the exemplary embodiments herein that further modifications, equivalents, and variations are possible. Further, any range of numbers recited in the specification or claims, such as that representing a particular set of properties, units of measure, conditions, physical states or percentages, is intended to literally incorporate expressly herein by reference, or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

What is claimed is:

1. A system, comprising a computer programmed to do the following:
upon receiving a user input, transports a carrier having a personal conveyance device thereon from a rear portion of a vehicle to a side portion of said vehicle,
wherein said carrier is transported to said side portion of said vehicle using a transport rack rail that is coupled to said rear portion and side portion of said vehicle, and
wherein said carrier is transported on said transport rack rail using a drive module.

2. A system according to claim 1, wherein said carrier comprises a platform via which said personal conveyance device is transported.

3. A system according to claim 1, wherein said personal conveyance device comprises a wheelchair, a motor chair or a scooter.

4. A system according to claim 1, wherein said transport rack rail comprises a rack and pinion rail, chain and sprocket rail, or a worm drive rail.

5. A system according to any one of claim 1, wherein said transport rack rail is coupled to said vehicle by support arms affixed to said vehicle's frame or other stable location.

6. A system according to claim 1, wherein said drive module comprises a power pinion module.

7. A system according to claim 1, wherein said carrier further comprises a lift coupled thereto, which allows carrier to be lowered or raised to a desired location.

8. A system according to claim 7, wherein said computer is further programmed to lower or raise said carrier to said desired location upon input from said user.

9. A system according to claim 1, wherein said computer is further programmed to return said carrier to said rear of said vehicle upon input from said user.

10. An apparatus for carrying a personal conveyance device on a vehicle and transporting said personal conveyance device around said vehicle; comprising:
a carrier for holding said personal conveyance device;
a transport rack rail to be mounted on said vehicle on which said carrier is transported around said vehicle; and
a drive module coupled to said carrier that transports said carrier on said transport rack rail.

11. An apparatus according to claim 10, wherein said transport rack rail comprises a rack and pinion rail, a chain and sprocket rail, or a worm drive rail.

12. An apparatus according to claim 10, wherein said transport rack rail is coupled to said vehicle by support arms affixed to said vehicle's frame or other stable location.

13. An apparatus according to claim 10, wherein said drive module comprises a power pinion module comprising a drive pinion, an electric power source and a digital receiver.

14. An apparatus according to claim 10, wherein said carrier further comprises a lift coupled thereto, which allows carrier to be lowered or raised to a desired location.

15. An apparatus according to claim 10, wherein one or more portions of said transport rack rail may be detached and reattached to said vehicle.

16. An apparatus for carrying a personal conveyance device on a vehicle and transporting said personal conveyance device around said vehicle, comprising:
a carrier for holding said personal conveyance device;
a transport rack rail to be mounted on said vehicle upon which said carrier is transported around said vehicle, said transport rack rail extending from a rear portion to a side portion of said vehicle;
a drive module coupled to said carrier that transports said carrier on said transport rack rail; and
wherein said carrier, when located at the rear portion of said vehicle, is proximate to a fixed base that supports said carrier.

17. An apparatus according to claim 19, wherein said transport rack rail comprises a rack and pinion rail, a chain and sprocket rail, or a worm drive rail.

18. An apparatus according to claim 19, wherein said transport rack rail is coupled to said vehicle by support arms affixed to said vehicle's frame or other stable location.

19. An apparatus according to claim 19, wherein said drive module comprises a power pinion module.

20. An apparatus according to any one of claims 19 to 24, wherein said carrier further comprises a lift coupled thereto, which allows said carrier to be lowered or raised to a desired location.
